(19) United States
(12) Patent Application Publication
(10) Pub. No.: US 2022/0057027 A1
(43) Pub. Date: Feb. 24, 2022

(54) Twin PVC Coupling Connector

(71) Applicant: George Diaz-Granados, Jacksonville, FL (US)

(72) Inventor: George Diaz-Granados, Jacksonville, FL (US)

(21) Appl. No.: 16/995,978

(22) Filed: Aug. 18, 2020

(51) Int. Cl. F16L 21/06

(52) U.S. Cl. CPC F16L 21/06

(57) ABSTRACT

The inventors idea originated from the inventor's personal experience doing plumbing work and encountering much difficulty using the conventional cylinder PVC connector. It occurred to the inventor that there had to be a better option. The other options that are available are much more expensive and less reliable and do not resemble in any way the inventor's PVC Coupling Connector. The essence of the idea, or what is new in the art of the idea, is not so much the design as shown on FIG. 1 but the concept of using two halves to serve the same purpose of the conventional PVC connector and obtaining the same results.

The PVC Coupling Connector is generally made of PVC plastic (polyvinylchloride) but other plastic types like PLA, ABS, etc. may be used if appropriate. The 3D view in page 1 and dimensions specified in page drawings 2, and 3 are accurate and for illustration purposes only but not to scale on the page. The size of the PVC Coupling Connector will vary in size as needed to adapt and fit the different size PVC pipe used. Most common pipes come in size ½″, ¾′, 1″, and reaching sizes as large as 4″ and more.

### BACKGROWN OF THE INVENTION

The PVC Coupling Connector is made of PVC plastic (polyvinylchloride), the same plastic generally used in a variety of applications in the building and construction, heath care, electronics, automobile and other sectors, in products ranging from piping and siding, blood bags and tubing, to wire and cable insulation, windshield system components and more. The purpose of the invention us to provide another option for consumers, plumbers and electrical professionals when needing to connect or attach two PVC pipes together. The invention here described resolves the problem that occurs when trying to connect pipes that are damaged and need to be reconnected or join back together. The pipes may be inside a wall or buried in the ground or other location that makes it very difficult to insert the conventional coupling connectors now available in the market place. The connectors' couplings presently available need a PVC pipe partially inserted in it through one side and then another PVC pipe through the other side. Because, in an existing building or wall, the two pipes that need to be connected are already in place (preinstalled) inserting a conventional PVC connection is very difficult. The reason been that the two pipes that need to be connected need to be close together; with no more than usually ½″ of separation from each other making it difficult for both sides of the connector to be inserted. Part of the problem arises from the fact that this most commonly used conventional connector design allows the pipe to be inserted only half way. The pipe breaks because there is a tendency to try to bend one of the pipe conduits to insert it in the other side of the connector opening causing the PVC pipe to break or crack.

The inventor's PVC Coupling Connector solves this problem because it comes in two halves. Each have can be placed on each side of the two pipes, even in the most tight spaces, joining them together and forming one single connector that when glued together, with standard PVC glue, will seal all pieces and work as well as using the existing one coupling connectors now in the market. This is a great option for consumers and professional plumbers saving them time and money.

The inventor's PVC Coupling Connector is not an improvement on the conventional PVC connector already in the market place, rather is another way of connecting or repairing broken PVC pipes when the conventional PVC connector is less practical making the PVC Coupling Connector a better option. It serves the same purpose and function as the conventional PVC connector.

### BRIEF SUMMARY OF THE INVENTION

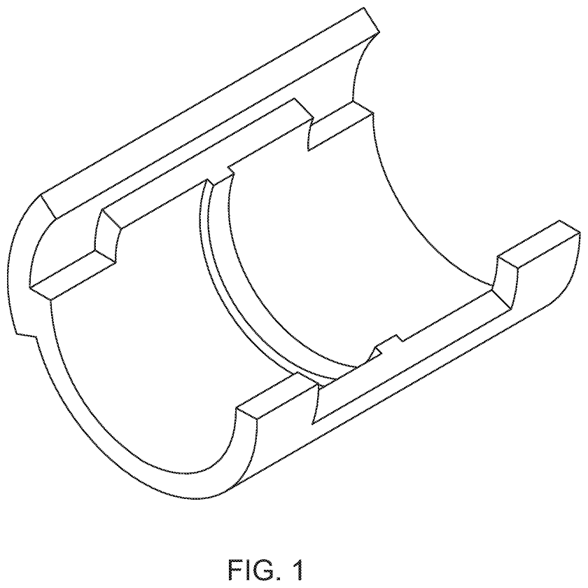

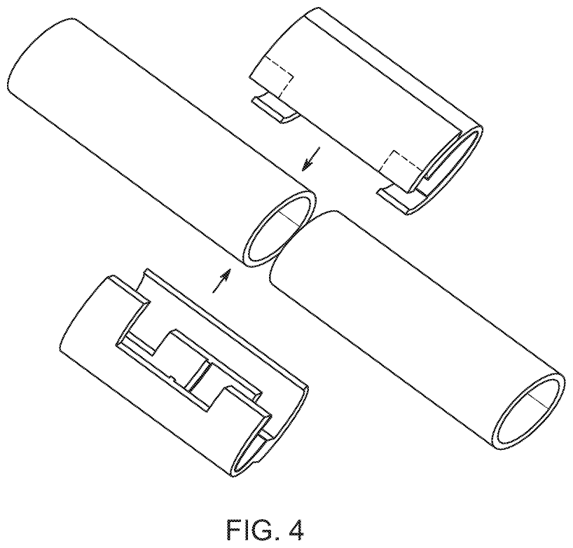

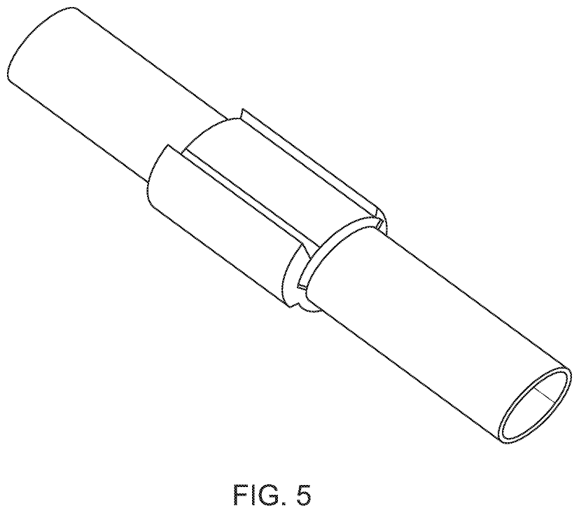

FIG. 1 shows the PVC Coupling Connector in 3D view. It takes two of FIG. 1 to get the job done. FIG. 4 and FIG. 5 illustrates how the PVC Coupling Connector is used to connect and join two separate PVC pipes to form a single pipe conduit allowing, for example, water to flow through the pipe without any leakage. The PVC Coupling Connector is glued together using the PVC glue commonly used by plumbers for this purpose. The Inventor's PVC Coupling Connector has been tested numerous times using different size PVC Coupling Connectors with 100% success.

### BRIEF DESCRIPTION OF THE SEVERAL VIEWS OF THE DRAWING

A) FIG. 1 shows the PVC Coupling Connector in 3D

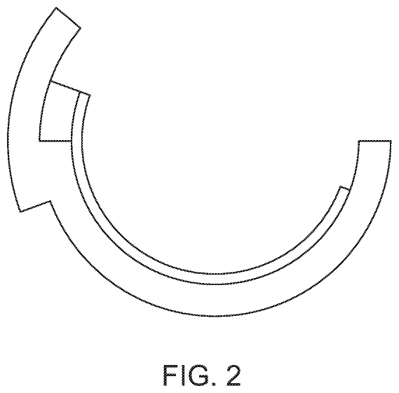

B) FIG. 2 shows an elevation view of FIG. 1 from a different view perspective.

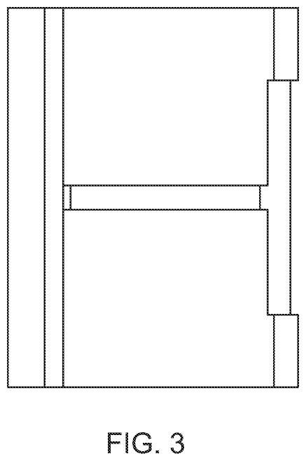

C) FIG. 3 shows another elevation view of the PVC Coupling Connector.

D) FIG. 4 illustrates how two PVC Coupling Connectors (FIG. 1) attach to two separate PVC pipes and weld them together.

E) FIG. 5 is an illustration showing the two PVC Coupling Connectors fully attached to the two PVC pipes.

### DETAIL DESCRIPTION OF THE INVENTION

The PVC Coupling Connector is made of PVC plastic (polyvinylchloride) commonly used by most plumbers. It is the same material of most PVC pipes made in the United States. The difference shown in this invention is that it functions by using two PVC Coupling Connectors that are identical and wrap around two disconnected PVC pipes to form one single fully sealed conduit pipe that will allowed water, other chemicals or materials to flow through it uninterrupted. This is an improvement in the way it is installed versus the single connectors available in the market place today. As explained in the Background of the Invention section above, it provides another option to repair broken PVC pipes when it becomes difficult to insert the singular cylinder shape connectors that are now available. It is an improvement because it makes it easier by saving time and money when repairing broken pipes were space is tight and difficult to install the conventional pipe connector used today.

1. The inventor claims the patent protection for this invention as described in all sections above. The protection requested refers to the concept and not only the design of the invention as described above. The claim relates to the inventors idea that two halves of a PVC connector are used effective to repair and connect two PVC pipes in a way that such item is not available in the market place of the United States today. And as such, if no patent claims have been made for this type of invention we claim the right to granted a non-provisional patent for this invention.
